(19) United States
(12) Patent Application Publication
(10) Pub. No.: US 2014/0174276 A1
(43) Pub. Date: Jun. 26, 2014

(54) Stringed Instrument Improvement

(71) Applicant: Brent Deck, Kansas City, KS (US)

(72) Inventor: Brent Deck, Kansas City, KS (US)

(21) Appl. No.: 14/085,790

(22) Filed: Nov. 20, 2013

Related U.S. Application Data
(63) Continuation-in-part of application No. 12/842,028, filed on Jul. 22, 2010, now abandoned.
Application No. 12/842,028 is a continuation-in-part of application No. 13/494,007, filed on Jun. 11, 2012.
Application No. 13/494,007 is a continuation-in-part of application No. 13/424,357, filed on Mar. 19, 2012, now abandoned.
Application No. 12/842,028 is a continuation-in-part of application No. 12/283,668, filed on Sep. 15, 2008, now Pat. No. 8,252,999.
(60) Provisional application No. 61/838,338, filed on Jun. 23, 2013.
(60) Provisional application No. 61/454,495, filed on Mar. 18, 2011.

(51) Int. Cl. G10D 3/14

(52) U.S. Cl. CPC G10D 3/146
USPC 84/313

(57) ABSTRACT

This invention relates to improvements to a stringed musical instrument, and more particularly to guitar design for use with transposing vibrato mechanisms.

Vibrato devices for guitars are known. The present device and method improve the ability to of a player to bend entire chords in a manner that maintains harmonic relationship between the individual strings.

The invention also included improved manual controls and means to extend the transposing range of such a vibrato device.

This application claims priority to U.S. provisional application 61/838,338 filed Jun. 23, 2013 by the same applicant.

This application is a continuation in part of U.S. non-provisional application Ser. No. 13/494,007 filed Jun. 11, 2012 by the present applicant, which was a continuation in part of U.S. non-provisional application Ser. No. 13/424,357 filed Mar. 19, 2012 by the present applicant, and which claimed priority to U.S. provisional application 61/454,495 filed Mar. 18, 2011 by the same applicant

This application is a continuation in part of U.S. non-provisional application Ser. No. 12/842,028 filed Jul. 22, 2010 by the present applicant, which claimed priority to U.S. provisional application 61/271,586 filed Jul. 22, 2009 and to PCT application U.S. Ser. No. 10/27,736 filed Mar. 17, 2010.

The disclosure of this application incorporates by reference the entirety of said U.S. application Ser. No. 12/842,028 filed Jul. 22, 2010, and published U.S. provisional application 61/529,910 filed Aug. 31, 2011, by the present applicant.

The disclosure of this application is also supplemented by incorporation by reference to every claim previously submitted during prosecution of the said U.S. application Ser. No. 12/842,028.

Said incorporation by reference shall supplement the present disclosure without in any way limiting the scope or meaning of the disclosure or claims of the present application or subsequent applications.

### FIELD OF INVENTION

The present invention relates to devices which enhance the expressive qualities of a stringed musical instrument by empowering the artist to “bend” notes and chords in a harmonic manner.

### SUMMARY

The application discloses various embodiments having guides adjustably fixed relative to a pivoting tailpiece, causing the strings to be stretched or relaxed when the tailpiece is rotated, enabling maintenance of relative pitch among strings.

The application discloses dual axis control, enabling a musician to sweep easily from “bend” to “dive” (sharp to flat) while using the muscles on only one side of the hand and wrist. Dual axis control further allows biasing a tailpiece against a separate stop on a separate axis after either a bend or a dive, with enhanced stability at neutral pitch, and requiring no locking mechanism.

The application discloses various embodiments of a cam-enabled return spring to maintain neutral tuning when the device is released without adversely affecting motion of the device.

Embodiments also include a beneficial combination of pitch-relative and non-pitch-relative vibrato means, where a non-pitch-relative vibrato displacement may be used to compensate for non-linearities in string tension while transposing over large spans.

Also disclosed are various embodiments enabling improved electronic control, improved limitation on string stress, improved float about a neutral position, improved flex compensation, improved string anchoring, improved fulcrum support, and improved bending means for individual strings.

### BRIEF DESCRIPTION OF DRAWINGS

FIGS. 1 through 11 are perspective views of various embodiments of a neck mount bracket.

FIG. 12 is an end view of an embodiment of a guitar body and neck connected by a bracket.

FIG. 13 is an bottom view of an embodiment of a guitar body and neck connected by a bracket.

FIG. 14 is an end view of an embodiment of a guitar body and neck connected by a bracket.

FIG. 15 is an bottom view of an embodiment of a guitar body and neck connected by a bracket.

FIG. 16 is a cross sectional end view of an embodiment of a guitar body and neck connected by a bracket including keying means.

FIG. 17 is an bottom view of an embodiment of a guitar body and neck connected by a bracket including keying means.

FIG. 18 is a side view of an embodiment of a fretboard extender.

FIG. 19 is a side view an embodiment of a body, neck, and fretboard extender connected to an embodiment of a bracket.

FIG. 20 is a side view an embodiment of a body and neck connected to an embodiment of a bracket.

FIG. 21 is a side view an embodiment of a body and neck connected to an embodiment of a bracket.

FIG. 22 is a side view of an embodiment of a fretboard extender.

FIGS. 23 and 24 are side views of vibrato means having tension limiting means for one or more strings.

FIGS. 25A and 25B are end and bottom views of an instrument with a substantially flat (preferably a high modulus composite) plate keyed on two edges into an instrument body, secured for example by adhesive means

FIG. 26A shows an end view of an embodiment of a vibrato control arm having a rotational axis substantially parallel to the strings, where the body is cutaway to show an embodiment of vibrato connection and biasing means.

FIG. 26B show a top view of an embodiment of a vibrato control arm having a rotational axis substantially parallel to the stings, and of drum on an axis substantially parallel to the strings for manipulating an electronic rotation sensor.

FIG. 26C shows an end view of an embodiment of a vibrato control having a rotational axis substantially parallel to the stings, where the control comprises at least a partially arcuate surface.

FIG. 26D shows an end view of an embodiment of a vibrato control having a rotational axis substantially parallel to the stings, where the control arm comprises a substantially planar surface

FIG. 26E is a top view of an embodiment substantially similar to that of FIG. 26B.

### DISCUSSION

### Parallel Control Axis

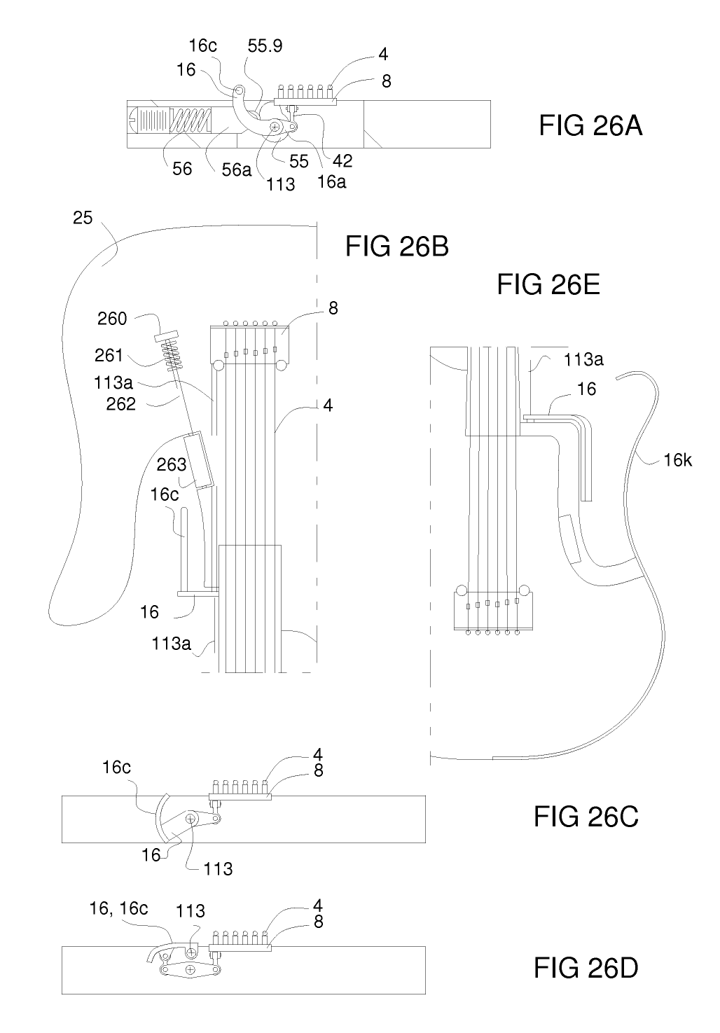

FIGS. 26A and 26B illustrate an example where the pivot means is a shaft 113a rotating on axis 113, preferably substantially below and parallel to the strings. An arm 16, preferably curved to provide suitable neck and body clearance, radiates from said shaft, having a handle 16c, also preferably parallel the strings 4.

The shaft engages the vibrato unit by suitable means, for example by a connecting rod 42 pivoting on crank arm 16a extending from the shaft 113a, and attached to a moveable member 8, as illustrated in FIG. 26A.

The device may utilize any biasing means, e.g. simple bias springs (not shown) connecting the rotating member 8 or a crank from shaft 113a to the instrument body 25.

In the example shown in FIG. 26A, the biasing means for the vibrato rotating member 8 is provided by return spring 56 pressing cam follower 55.9 toward cam 55, also rigidly attached to shaft 113a. The angle of contact of the cam with the follower is preferably adapted generate forces opposed to the string tension. Preferably a slight change in angular contact at the neutral position provides tuning stability when the return spring 56 is properly adjusted, as previously disclosed.

The cam follower 55.9 rotates on a shuttle 56a (or alternatively a rocker) providing stable contact between cam 55 and cam follower 55.9 by confining the cam follower to a linear or arcuate path, and resisting unwanted tangential motion of cam follower about the cam.

The actuation arm 16c, substantially parallel to the strings in FIGS. 26A and 26B may alternatively have the shape of a cylindrical control surface (not shown), preferably coaxial with shaft 113a, and of sufficient radius and surface friction to enable a rolling action with the palm side of the fingers while playing.

In examples of alternative embodiments, the combination of arm 16, shaft 113a, and handle 16c, take the form of a full or partial drum surface as in FIG. 26C, or a contoured or substantially planar surface (for example a pickguard) hinged along an axis substantially parallel to the strings, as in FIG. 26D.

In alternative embodiments, the biasing means includes a cam and follower, at least one of which is moveable relative to a base, where rotation of the arm 16 is associated with relative motion of said cam and cam follower, such that rotating the arm 16 in one direction (preferably downward, away from the strings) alters the bias position of the main member 8 in a direction of increased bias spring force, for example similar to the device described with respect to FIG. 9C. Shaft 113a may connect directly or indirectly to said one or more cam, and may be configured to bend or swivel or link to intermittent arm or shaft means.

### Bend Limiter

In the embodiments of FIGS. 23A and 23B a separately biased guide crank 220 is provided for at least one sting. It preferably rotates on a common axis 1 with main rotating member 8, and rests against a stop 222 relative to main member 8. As main member 8 rotates in a bend direction, guide crank 220 rotates with it under the force of separate bias spring 122, until preferably adjustable (by an adjusting screw, for example) stop 221 engages base 8. In the example, crank 220 comprises string anchor means 10, for example a slot positioned to enable string 4 to wrap over the surface of guide 6. In a preferred embodiment, a quickly changeable adjuster, for example a sloped or stepped axial cam 221a in FIG. 23A between stop 221 and base 69 (pivotable about an axis 221x), enables a user to quickly select from among 2 or more bend limits during a performance. The range of adjuster 221a preferably is sufficient to enable adjusting the limit to totally prevent bend (sharpening) motion of crank 220 relative to base 69. Adjuster 221a preferably comprises knob or lever means as shown to enable quick adjustment.

The separate crank 220 preferably includes string anchor means separate from the main member, for example a slot for receiving the ball end of a string, as shown, preferably far enough from the guide 6 to isolate the guide from the stiffness of ball end lashing. Main member may optionally be partially biased by separate balancing spring 40.

The radius of guide 6 from axis 1 may be adjustable, for example by set screws on a flexible guide bracket 220, as illustrated in FIG. 23C, or it may be fixed, for example as illustrated in FIG. 23A. A single fixed guide permits all other guides to be adjusted relative to the fixed guide to accomplish tuning of the device. Actuation effort may be adjusted by modifying the purchase of the actuator mechanism between the control arm and main member (not shown).

### Neck Mounts

The application describes embodiments of a bracket and a method for connecting, a neck to a guitar body in a manner leaving room for placement of the thumb of the fretting hand under the neck in the area of the connection.

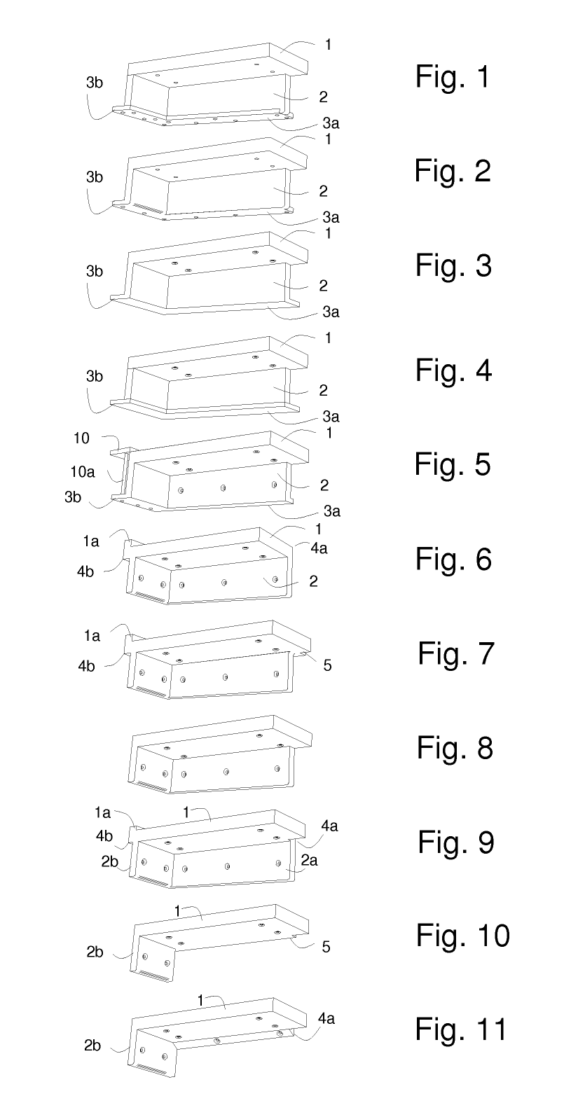

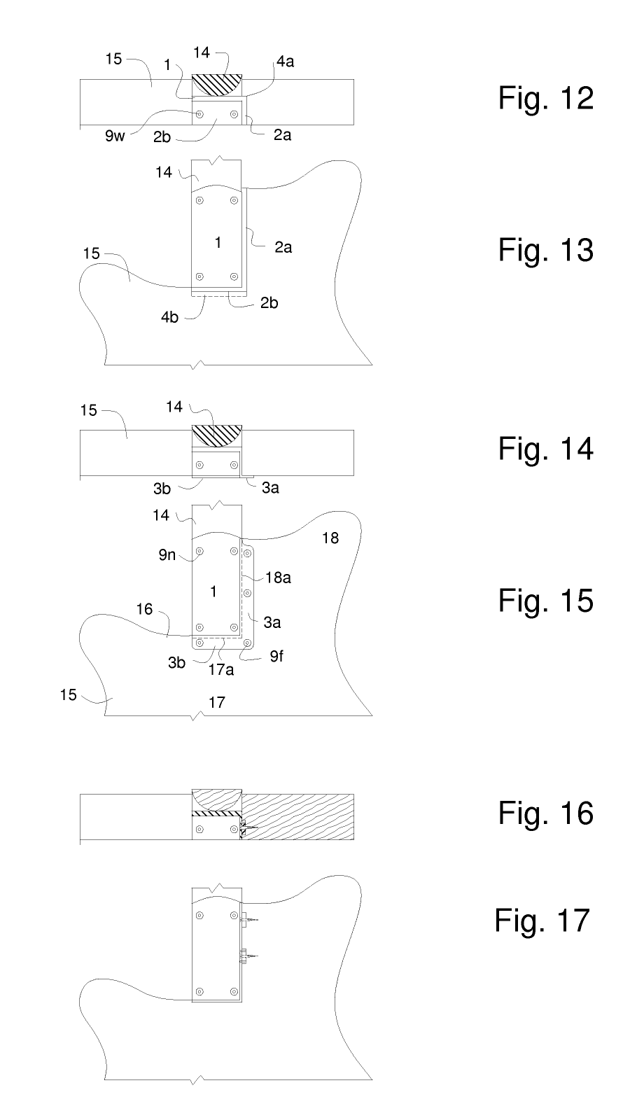

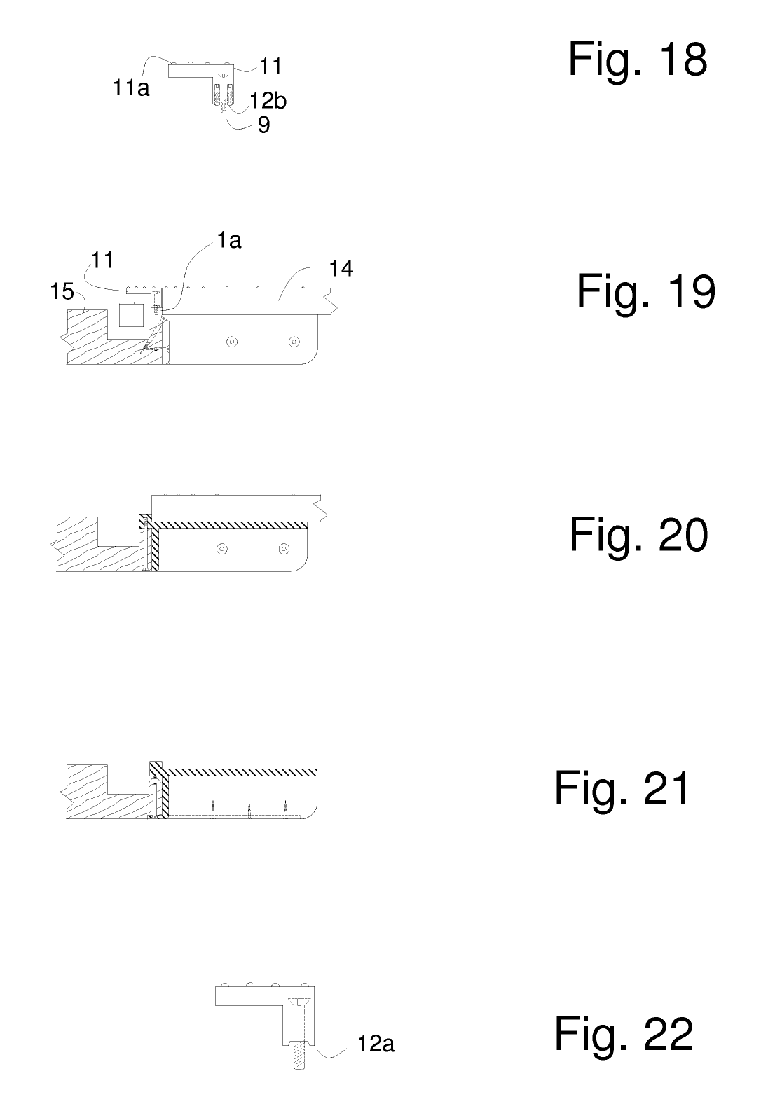

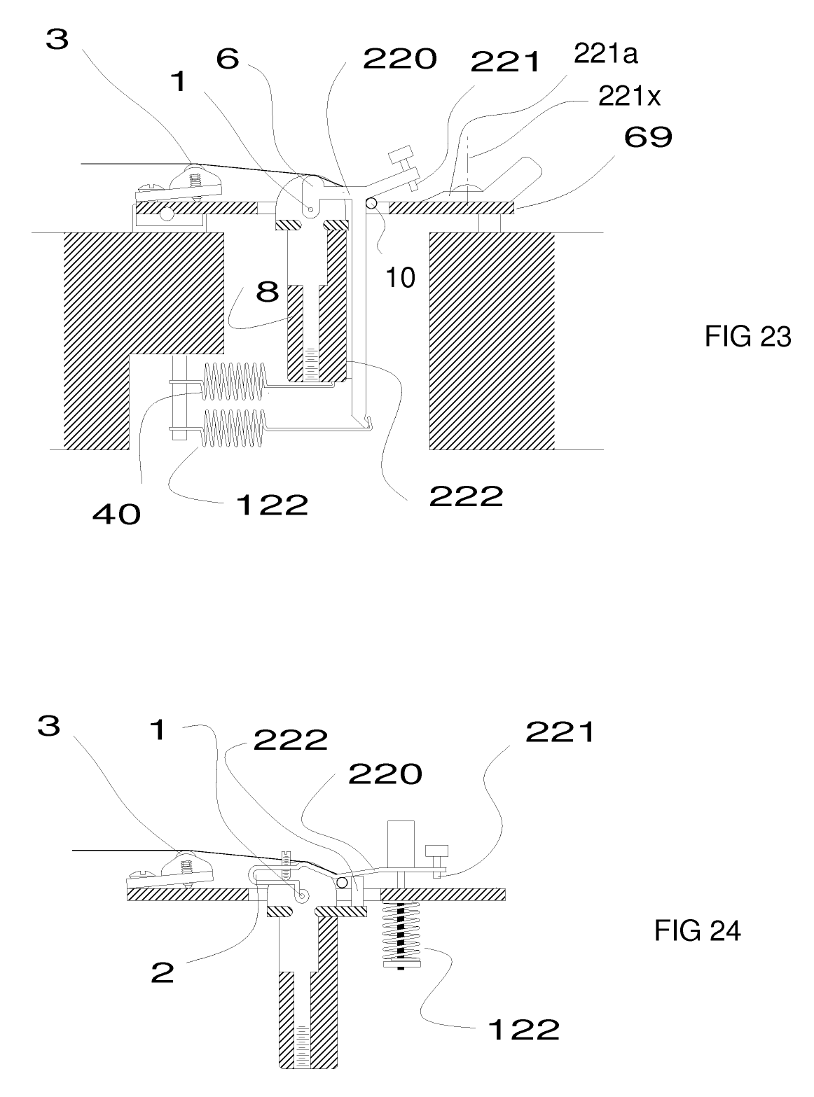

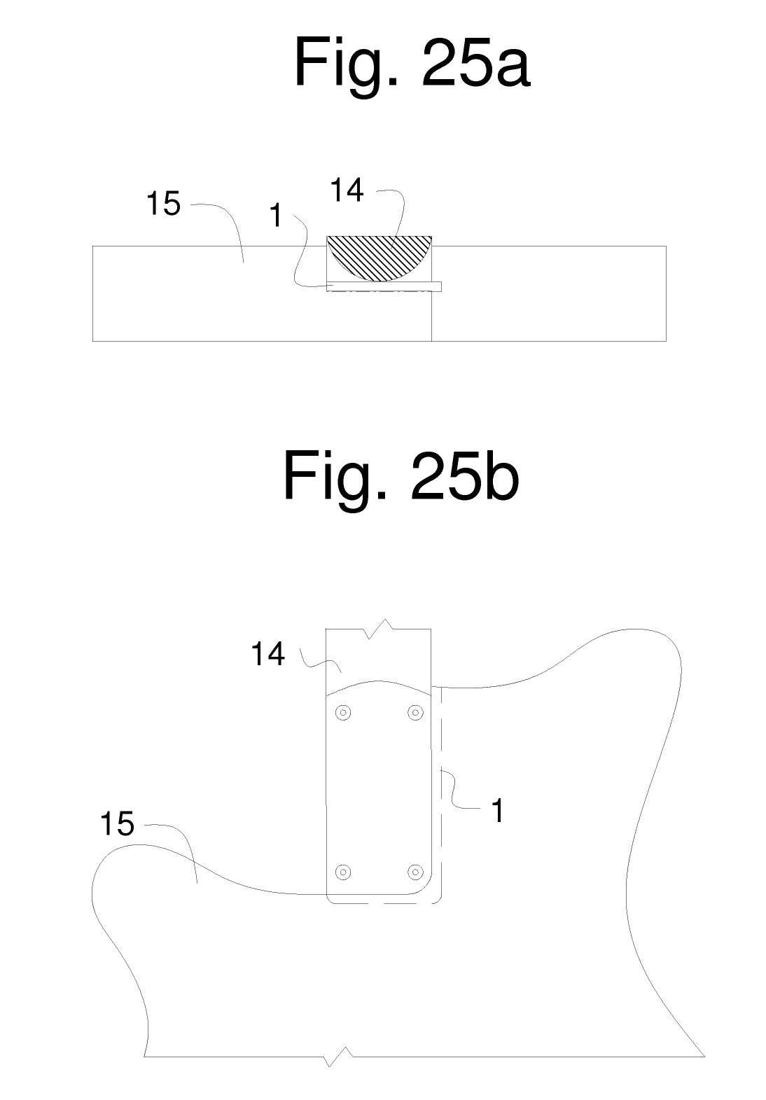

FIGS. 1 through 5 show embodiments of a bracket having a base 1, web 2, and front and rear flanges 3a and 3b. In FIG. 15 flanges 3a and 3b stabilizing the neck 14 by connecting it in a triangular pattern along a heel cut 17a and a longitudinal cut 18a in the forward most portion 18 of the body 15. Fasteners 9f in the figure secure the bracket to the body, while fasteners 9n (typically wood screws or machine screws) connect the neck to the bracket.

The bracket is preferably fabricated, cast, or assembled from high modulus material for example steel, aluminum, titanium, or carbon composite.

The higher modulus at the bracket allows a thin base on the order of 6mm. Alternative embodiments in FIGS. 6 through 11 utilize shoulders 4a and 4b or keys 5 (for example rectangular keys or discs) fitted to matching surfaces of the body. Keys may be stabilized to the bracket by, for example, pins 7, recess 8, precision screw shaft 6, or welding or press fit.

In the various figures, flanges 3a and 3b, or shoulders 4a and 4b, or keys 5, are preferably configured to mate with opposing surfaces on the guitar body in an orientation opposing motion in at least one direction normal to the face of the body 15.

An optional neck heel stop 1a also optionally supports an optional cantilevered fretboard extender 11, preferably connected by one or more screws. Height and angle of adjuster 11 may be adjusted by shims, machinable feet 12a, or setscrew feet 12b. Extender 11, preferably aluminum, includes frets 11a, preferably cast or machined into the extender.

In an alternative embodiment shown in FIGS. 23A and 23B, a single plate 1 of preferably a high modulus composite material (for example carbon-epoxy) is adhesively secured into keyways at the end and one side of the neck pocket of body 15. The plate is preferably molded or predrilled with holes for attachment to a neck, the holes preferably used in locating the plate in an assembly jig for adhesive bonding to the body.

I claim:

1-5. (canceled)

6. Control apparatus for a pitch changing device for a musical instrument, said instrument having at least two strings suspended in tension relative to a body, a major span of said at least two strings substantially defining a string plane, said pitch changing device comprising a first member adapted to directly or indirectly engage at least two said strings, such that displacement of said first member relative to a base causes a change in tension of said at least two strings, said apparatus comprising:
a control lever,
at least one spring,
at least one fulcrum defining discrete first and second control axes,
a distal portion of said lever defining a handle,
said handle angularly displaceable in first and second control directions from a neutral position about said first and second control axes respectively,
the direction of said first control axis configured to be substantially normal to the direction of said second axis when said handle is at said neutral position,
said control lever pivotable in said first control direction about said first control axis and in said second control direction about said second control axis,
said lever adapted to directly or indirectly engage said first member and at least one said spring such that rotation of said lever in at least one of said two control directions causes a change in string tension, and
such that displacement from said neutral position of said handle in each of said first and second control directions is opposed by one or more of said spring force and said string tension,
return of said handle to said neutral position from said displacement urged by one or more of said strings and springs.

7. Control apparatus according to claim 6 and further comprising
first and second fulcrums defining said first and second discrete control axes,
a fulcrum connector adapted to connect said first and second fulcrums, said connector adapted to substantially fix said first and second control axes relative to said connector,
said fulcrum connector defining a transport,
said control lever pivotable relative to said transport in said first control direction about said first axis from a neutral position,
said transport pivotable about said second axis relative to said base or to said first member,
such that rotation of said lever in said second control direction about said second axis causes rotation of said transport in said second control direction about said second axis,
said lever adapted to engage said first member and said base such that motion of said handle in a first control direction substantially tangential to said first axis displaces said first member in a direction of increasing string tension,
said lever configured to urge said handle toward said neutral position from displacement in said first control direction by tension of said strings in engagement with said first member,
at least one said spring adapted to urge said transport toward a stop defining a biased position,
said spring urging said handle toward said neutral position from displacement in said second control direction,
said apparatus adapted to engage said first member and said base such that rotation of said transport from said biased position displaces, or enables string tension to displace, said first member in a direction of reduced string tension,
said apparatus configured such that, when said handle is at said neutral position, one said control axis extends in a direction substantially normal to said string plane, while the other extends in a direction substantially normal to said strings and parallel to said string plane.

8. Pitch control apparatus according to claim 7,
said base or said first member defining a transport base,
said second fulcrum adapted to connect said transport to said transport base,
said apparatus comprising surfaces of engagement between said transport and transport base, said surfaces defining a dive bias stop,
at least one said spring adapted to urge rotation of said transport in a direction of engagement of said dive bias stop,
said apparatus configured such that rotation of said transport from engagement of said dive bias stop displaces alters the engagement of said lever with said first member or base such that said first member is displaced in a direction of reduced string tension.

9. Control apparatus according to claim 7, said base defining a first base displaceable relative to a second base, said apparatus comprising said first base.

10. Apparatus according to claim 13, said apparatus comprising:
at least one bias limiter,
an adjuster defining a transposer,
said transposer comprising a lock,
said pitch changing device configured or configurable to substantially maintain relative pitch among said at least two strings during displacement of said first member from a home position,
said first member urged in a bias direction by said string tension or by at least one said spring opposing said string tension,
said bias limiter comprising first and second components,
said components adapted to be directly or indirectly associated with said first member and said base, respectively,
engagement of said first and second components of said bias limiter adapted to resist displacement by said strings or springs in said bias direction of said first member from said home position,
said lever adapted to directly or indirectly engage said first member and said base, such that rotation of said lever about a control axis displaces said first member from said home position,
said transposer adapted to directly or indirectly position said first or second component of said bias limiter relative to said base, said first member, or said control lever,
said displacement by said transposer displacing said home position of said first member relative to said base,
said lock adapted to enable fixing said adjuster at a position defining a transposed home position of said first member,
such that subsequent rotation of said control lever in at least one direction causes a displacement of said first member from said transposed home position, and such that while so displaced said first member is urged toward said transposed home position by said strings or said spring.

11. A device according to claim 10, comprising
an idler and
a transposing hub,
said hub pivotable about a transposing axis,
said idler adapted to operatively link said transposing hub with a component of said bias limiter,
said idler adapted to displace said component relative to said first member or said base or said lever when said transposing hub is rotated in at least one direction about said transposing axis,
where the angular displacement of said idler is smaller than that of said transposing hub within the operative range of said hub.

12. Control apparatus according to claim 6,
said first member pivotable about said second control axis relative to said base,
said lever pivotable about said first control axis,
said first control axis oblique to said first member and fixed relative thereto, with said lever adapted to operatively engage said base,
such that rotation of said lever in a first direction about said first control axis displaces said first member angularly about said second control axis from a biased position,
said oblique angle of said first control axis chosen such that the combined said rotation of said lever and said first member about their respective axes results in motion of said lever substantially in a plane substantially parallel to the plane of said strings.

13. Control apparatus for a pitch changing device for a musical instrument, said instrument having at least two strings suspended in tension relative to a body, a major span of said at least two stings substantially defining a string plane, said body defining the location of a reference plane parallel to said string plane, said strings between said reference plane and a pick space proximate said strings, said pitch changing device comprising a first member adapted to directly or indirectly engage at least two said strings, such that displacement of said first member relative to a base causes a change in tension of said at least two strings, said control apparatus comprising:
at least one fulcrum defining at least one control axis,
a control lever pivotable about at least one said control axis,
at least one spring,
a distal end portion of said lever defining a handle,
said lever and said at least one fulcrum configured to enable manual displacement of said handle in first and second control directions from a neutral position, each of said control directions substantially tangential about a said control axis associated with said control direction,
said handle, when at said neutral position, substantially defining the location of a neutral plane, said neutral plane perpendicular to said reference plane and parallel to said major span of at least one said string,
said first control direction corresponding to the smaller angular displacement of said handle about said associated control axis from said neutral plane toward said pick space,
said second control direction corresponding to the smaller angular displacement of said handle about said associated control axis from said neutral position toward said reference plane,
said lever adapted to directly or indirectly engage said first member, such that displacement from a neutral position of said handle in at least one said control direction causes an increase or decrease in said string tension, and
such that displacement from said neutral position of said handle in each of said first and second control directions is opposed by one or more of said spring force and said string tension,
said handle urged to return from said displacement by one or more of said spring force and said string tension.

14. Control apparatus according to claim 6,
said apparatus comprising at least one sensor
at least one said sensor adapted to vary at least one detectable electronic property with rotation of said control lever about at least said first control axis,
said varying of said property defining a signal,
said first control axis at rest adapted to extend in a direction substantially normal to said string plane,
said sensor configured to enable connection to a signal processor such that said connection enables said signal to be communicated to said processor.

15. Control apparatus according to claim 14,
said apparatus comprising first and second fulcrums defining said first and second control axes,
said first fulcrum adapted to connect said lever to first member,
said control lever pivotable about said first control axis relative to said first member,
said first member pivotable about said second control axis,
said second control axis having a direction substantially normal to said strings and substantially parallel to said string plane,
such that rotation of said lever about said second control axis rotates said first member about said second control axis.

16. A device according to claim 11, where engagement of said idler with said hub or with said bias limiter comprises a mechanical component selected from a list comprising cam, roller, rocker, crank, and screw.

17. Apparatus for a pitch changing device for a musical instrument, said instrument having multiple strings suspended in tension, where said pitch changing device is adapted to alter the tension of one or more strings in response to motion from a neutral position of either of at least two string-engaging members relative to a base, said apparatus comprising
first and second members, each displaceable relative to a base, each adapted to engage a discrete complement of at least one string,
at least one spring engaging said first member in opposition to the tension of said at least one string,
a first stop comprising surfaces of engagement between said first and second members,
said spring adapted to urge said first member in a direction of engagement with said second member at said first stop,
said second member adapted to urge said first member in a direction of reduced string tension by engagement at said first stop,
a control lever adapted to enable displacement of said second member at least in a direction of increasing string tension from a prior position,
such that said displacement enables said at least one bias spring to displace said first member in a direction of increasing string tension.

18. An apparatus according to claim 17 and further comprising a second stop,
said second stop comprising surfaces of engagement between said first member and said base,
such that, once engaged, said stop resists motion of said first member in a direction of increasing string tension.

19. Pitch control apparatus according to claim 36, said apparatus comprising:
bridge saddles substantially defining a bridge,
said bridge saddles associated with said second member,
said main fulcrum adapted to connect said first and second members,
said main axis substantially parallel to said bridge,
said first member pivotable about said main axis relative to said second member,
such that displacement of said second member relative to said base causes displacement of said first member relative to said base,
said second member configured such that displacement of said second member in a direction of reduced string tension elevates said bridge saddles from said instrument body.

20. Pitch control apparatus according to claim 19, said apparatus comprising:
at least one bias spring,
a base fulcrum defining a base axis substantially parallel to said bridge,
said second member adapted to be angularly displacable about said base axis relative to said base,
said at least one bias spring adapted to urge said second member in a direction of increasing string tension,
said compensator comprising a bias limiter,
said bias limiter comprising surfaces associated with said second member and said base,
engagement of said bias limiter surfaces resisting rotation of said second member in a direction of increasing string tension,
said at least one bias spring urging engagement of said bias limiter surfaces,
said compensator adapted to displace one of said bias limiter surfaces relative to said base or said second member,
such that said displacement of said bias limiter surface displaces said second member relative to said base in a direction of reduced string tension.

21. Pitch control apparatus according to claim 20,
said bias limiter comprising a cam and cam follower,
said cam comprising a displacing surface, engagement of said cam and cam follower urging said second member in a direction of reduced string tension,
said compensator adapted to associate said cam or follower with said first member or said control member such that rotation of said first member about said main axis or displacement of said control member alters the position of said cam relative to said follower,
said at least one adjuster adapted to adjust the engagement of said cam and said follower or to adjust the slope of a cam surface.

22. (canceled)

23. Apparatus according to claim 6 where said engagement of said
control apparatus with said pitch changing device comprises
first and second rollers adapted to have substantially skew axes,
said first roller directly or indirectly associated with said control lever,
said second roller directly or indirectly associated with a base or said first member,
said control lever pivotingly associated with said base or said first member,
said first roller adapted to be compressively engaged with said second roller in direct or indirect opposition to string tension or bias spring force
such that rotation of said control lever in at least one direction about said at least one axis causes displacement of said first member relative to said base.

24. A device according to claim 23, at least one of said rollers configured with an axial contour, such that during rotation of said lever in at least one direction about at least one said axis the purchase of said lever urging or enabling displacement of said first member varies according to the angular displacement angle of said lever.

25. A control apparatus according to claim 6 and further comprising a latch,
said latch comprising bolt and receiver surfaces
said latch adapted to resist displacement of a displaceable member when set,
said bolt surface adapted to be urged into operative proximity with said receiver surface directly or indirectly by rotation of said control lever in a latch-setting direction,
such that when said control lever is rotated in a direction associated with increasing string tension, said latch resists displacement of a displaceable member in a direction of decreasing string tension, or
such that when said control lever is rotated in a direction associated with decreasing string
tension, said latch resists displacement of a displaceable member in a direction of increasing string tension.

26. Apparatus according to claim 13,
said apparatus comprising a first fulcrum defining a first control axis, substantially parallel to the major span of a said string,
said first and second control directions tangential about said first control axis,
said first control direction defining angular displacement of said handle in a direction about said first control axis opposite from said second control direction.

27. Control apparatus according to claim 6, said apparatus comprising
first and second brake surfaces,
said first brake surface associated with said control lever,
said second brake surface associated with one of said first member and said base,
said first brake surface substantially cylindrical about said first control axis,
said brake surfaces adapted to be urged into braking engagement by the urging of said first member in a direction of reduced string tension by said strings,
such that engagement of said brake surfaces resists rotation of said lever about said first axis when said device is at rest,
and such that said brake surfaces disengage when said lever is rotated from an at-rest position in a direction of increasing string tension.

28. Control apparatus according to claim 6,
said pitch control device comprising a second member discrete from said first member and said lever,
said second member adapted to directly or indirectly engage at least one string,
said second member displaceable relative to a base such that displacement of said second member causes an increase or decrease in string tension
each of said first and second members urged by string tension or by spring force toward a respective stop defining a respective biased position relative to a said base,
said second member displaceable relative to said base or first member such that displacement of said second member causes an increase or decrease in string tension
said control lever adapted to separately engage each of said first and second members,
such that displacement of said handle in at least said first control direction displaces said first member from its biased position, and
such that displacement of said handle in at least said second control direction displaces said second member from its biased position.

29. Control apparatus for a pitch change device for a musical instrument, said instrument comprising at least two strings suspended in tension over a major span relative to a body, said major span of said at least two strings substantially defining a string plane, said pitch changing device comprising a first member adapted to directly or indirectly engage at least two said strings, such that displacement of said first member relative to a base causes a change in tension of said at least two strings, said apparatus comprising:
a compensator,
a second member, said first and second members each adapted to directly or indirectly engage a common set of at least two strings,
a main fulcrum comprising a main axis,
said first member pivotable about said main axis such that angular displacement of said first member about said main axis results in an increase or decrease of tension in said set,
said engagement of said first member with at least one said string configurable to substantially maintain relative pitch among the strings of said set during initial displacement of said first member about said main axis from a neutral position,
said second member displaceable relative to a base and configured or configurable such that displacement of said second member results in a more uniform change in the stretch of said strings than does displacement of said first member,
said apparatus comprising at least one displaceable control member, displacement of said control member adapted to change the angle of rotation of said first member about said main axis,
said compensator adapted to mechanically translate displacement of said control member or of said first member into displacement of said second member relative to said base,
said apparatus comprising at least one adjuster,
said at least one adjuster adapted to enable said translation to be characterized such that displacement of said second member by said compensator substantially offsets deflection of said instrument due to rotation of said first member about said main axis.

30. Apparatus according to claim 29, said apparatus comprising
a base fulcrum defining a base axis
said second member angularly displaceable about said base axis relative to said base,
said main fulcrum adapted to connect said first and second members,
said first member pivotable about said main axis relative to said second member,
said second member comprising bridge saddles,
said apparatus configurable such that rotation of said second member in a direction of reduced string tension elevates said strings from said instrument body.
